(19) United States
(12) Patent Application Publication
(10) Pub. No.: US 2026/0037225 A1
(43) Pub. Date: Feb. 5, 2026

(54) A METHOD FOR GENERATING VERIFIABLE QUANTUM RANDOM NUMBERS AND A SYSTEM THEREOF

(71) Applicant: Quanfluence Private Limited, Kothrud, Pune, Maharashtra (IN)

(72) Inventors: Sandeep K. GOYAL, Knowledge city, SAS Nagar, Punjab (IN); Biman CHATTOPADHYAY, Kundalahalli, Bengaluru, Karnataka (IN)

(21) Appl. No.: 18/676,969

(22) Filed: May 29, 2024

(30) Foreign Application Priority Data
May 29, 2023 (IN) 202321037110

(51) Int. Cl. G06F 7/58; G06N 10/20

(52) U.S. Cl. CPC G06F 7/588; G06N 10/20

(57) ABSTRACT

The present disclosure discloses a method and a system for generating verifiable quantum random numbers. The present disclosure uses continuous variable systems and homodyne detection to produce verifiable quantum random numbers. A plurality of analog to digital converter circuits are used to generate sequences of random number, which can be verified for violation of a Bell-CHSH inequality. The Bell-CHSH inequality is used to ensure true quantum nature of the generated random numbers.

### TECHNICAL FIELD

The present disclosure generally relates to the field of quantum computing. More particularly, the present disclosure relates to a method for generating verifiable quantum random numbers and a system thereof.

### BACKGROUND

Random number: A random number is generated by a random stochastic process. Individual numbers cannot be predicted but the collection of a large number of random number produced by a source follows certain statistical properties. Random numbers are generated by measuring a physical processes like throwing of dice, thermal noise etc. Random numbers can be generated by computational methods like pseudo-random-bit sequence (PRBS) generator. Random numbers are used in variety of applications like statistical sampling, cryptography, gaming, computer simulation, randomized design. A predictable random number can compromise the accuracy of results of these applications. Cryptographic protocols can fail to give security if the random number used in the protocol can be predicted. A random number generated by a physical process that obeys classical laws or by computational method rely on the complexity of the system or computation. It is in principle possible to predict random number from such source by observing the characteristics of the system and using other environmental signatures left by the source.

Quantum Random number: A quantum random number rely on quantum effects or phenomena, unlike the random number that rely on classical phenomenon, to generate random number. A quantum random number is produced by exploiting the randomness of measurements of a quantum system. The randomness of a quantum system is a fundamental property of nature. A quantum random generator can produce random numbers which cannot be predicted by the very nature of the system.

Verifiable Quantum: A system is verified to be quantum if there are measurements that can be performed on the system such that the measurement observations can be explained only through quantum mechanics theory. Classical mechanics theory cannot explain the measurement observations.

### A. Bell-CHSH (Clauser-Horne-Shimony-Holt) Inequality in Discrete Variable Systems

The Bell-CHSH violation is a process and method in quantum mechanics that demonstrates a contradiction with classical physics. It is a test designed to show that certain predictions of quantum mechanics cannot be explained by classical physics. Hence, a Bell-CHSH violation confirms the true quantum nature of a given system.

Discrete Variable (DV) System: Discrete Variable system is a system where the observable parameters take a discrete set of values. In particular, the Bell-CHSH inequality for a DV system is applicable for a binary system where the variable takes two values. The two values can be represented as 0 and 1. Alternately, the two values can be represented as −1 and +1. Such an entity is called qubit. Examples of discreate variables are photon energy, photon polarization.

The Bell-CHSH test involves measuring a set of dichotomic observable locally on a bipartite entangled system. For a two-qubit system S with A and B being the two spatially separated qubits, observables M1 and M2 can be measured on the qubit A and N1 and N2 on the qubit B. Then the Bell-CHSH inequality reads

$$\vert 〈 ( {M}_{1} ⊗ {N}_{1} + {M}_{1} ⊗ {N}_{2} + {M}_{2} ⊗ {N}_{1} - {M}_{2} ⊗ {N}_{2} ) 〉 \vert \leq 2 \qquad ( 1 )$$

for any classical system. However this inequality can be violated for quantum systems.

The observable is a quantity which can be measured by a suitable measurement instrument. A bipartite entangled system is a quantum mechanical phenomenon where a composite system can be partitioned into two parts whereby certain observables in one part are correlated to certain other observables in the other part.

For example, consider the two-qubit singlet state |ψ>=(|01>−|10>)/√2. The following choice of the measurement operators would yield a violation of the Bell-CHSH inequality:

$${M}_{1} = {σ}_{z} , \qquad ( 2 )$$

$${M}_{2} = {σ}_{x} , \qquad ( 3 )$$

$${N}_{1} = ( {σ}_{z} + {σ}_{x} ) / \sqrt{2} \qquad ( 4 )$$

$${N}_{2} = ( {σ}_{z} - {σ}_{x} ) / \sqrt{2} . \qquad ( 5 )$$

Where, σ_{z}, and σₓ, are Pauli matrices.

### B. Bell-CHSH Type Inequality for Continuous Variable (CV) Systems Using Homodyne Measurements

Continuous Variable (CV) system: Continuous Variable system is a system where the observable parameters take a continuous set of values. Example of continuous variable is electrical field of a light mode.

Homodyne: Homodyne measurement procedure measures the electrical field of a light mode. Homodyne measurement circuit is a well-known art in the field of photonics and optics. The electrical field can be decomposed into two orthogonal components which are called field quadratures. The two field quadratures are called X-quadrature and P-quadrature. A homodyne measurement can be done in a particular setting which would give measurement of either X-quadrature or measurement of P-quadrature. A balanced homodyne circuit measure the optical light mode and gives an electrical analog signal. This electrical signal can be a current or a voltage. The electrical voltage can be further converted to a digital code by an analog-to-digital converter.

Mach-Zehnder interferometer (MZI): A Mach-Zehnder interferometer takes in two input modes of light, cause interference between the light modes and gives out two output modes of light. Mathematically, this operation is called a unitary operation on two modes of light. Mach-Zehnder interferometer is a well-known art in the field of optics, photonics.

To achieve Bell-CHSH violation in CV systems, a source, which can prepare a four-mode entangled states is needed. These four modes are equally distributed among two spatially separated parties say Alice and Bob. Performing local measurements by the two parties can yield intensity-intensity correlations which can be used to show the Bell-CHSH violation in some particular scenarios. The protocol to show Bell-CHSH violation goes as following:

The source S generates a four-mode correlated optical state. These modes are named {ah, av} and {bh, bv} and distributed among Alice and Bob: {ah, av} go to Alice and {bh, bv} go to Bob. ah, av, bh, bv are quantum mechanical creation operators of modes as defined in quantum optics.

Alice and Bob can mix their corresponding modes using Mach-Zehnder interferometers to produce two different orthogonal modes, say a±(θ) and b±(φ), which are defined as

$${a}_{+} ( θ ) = cos θ {a}_{h} + sin θ {a}_{v} , ; {a}_{-} ( θ ) = cos θ {a}_{v} - sin θ {a}_{h} \qquad ( 6 )$$

Same goes for the b modes.
Measuring these modes can result in the intensity-intensity correlation functions R^{ij}(θ_{A},θ_{B})=<a†ᵢ(θ_{A})aᵢ(θ_{A})b†ᵢ(θ_{B})bᵢ(θ_{B})>.
Here i,j∈{±}.
This intensity-intensity correlation function R^{ij} is related to the expectation value E(θ_{A},θ_{B}) of the measurement in θ_{A},θ_{B} basis as

$$E ( {θ}_{A} , {θ}_{B} ) = \frac{{R}^{++} ( {θ}_{A} , {θ}_{B} ) - {R}^{+ -} ( {θ}_{A} , {θ}_{B} ) - {R}^{- +} ( {θ}_{A} , {θ}_{B} ) + {R}^{--} ( {θ}_{A} , {θ}_{B} )}{{R}^{++} ( {θ}_{A} , {θ}_{B} ) + {R}^{+ -} ( {θ}_{A} , {θ}_{B} ) + {R}^{- +} ( {θ}_{A} , {θ}_{B} ) + {R}^{--} ( {θ}_{A} , {θ}_{B} )} \qquad ( 7 )$$

In order to show the Bell-CHSH violation in CV systems, a four-mode entangled state |ψ> and four parameters θ_{A},φ_{A} and θ_{B},φ_{B} are needed such that

$$\vert E ( {θ}_{A} , {θ}_{B} ) + E ( {θ}_{A} , {φ}_{B} ) + E ( {φ}_{A} , {θ}_{B} ) - E ( {φ}_{A} , {φ}_{B} ) \vert > 2 \qquad ( 8 )$$

Converting intensity-intensity correlations into quadrature measurements:

Quadrature measurements and Quadrature operators: Quadrature measurements are expressed in the field of quantum optics by quadrature operators.
The quadratures operators xᵢ, yᵢ, pⱼ, qⱼ and the field operators aᵢ, bᵢ are related as

$${x}_{j} = ( {a}_{j} + {a}_{j}^{†} ) / \sqrt{2} ; {p}_{j} = i ( {a}_{j} + {a}_{j}^{†} ) / \sqrt{2} , \qquad ( 9 )$$

$${y}_{j} = ( {b}_{j} + {b}_{j}^{†} ) / \sqrt{2} ; {q}_{j} = i ( {b}_{j} + {b}_{j}^{†} ) / \sqrt{2} , \qquad ( 10 )$$

and the number operator a†ⱼaⱼ=(x²ⱼ+p²ⱼ−1)/2.
Similarly, the operators a_{±}(θ) and b_{±}(φ) can also be expressed in terms of quadrature operators.
Hence, in the expression of R^{ij}(θ_{A},θ_{B}) the field operators can be replaced with the quadrature operators as

$${R}^{ij} = \frac{1}{4} 〈 ( {x}_{i}^{2} + {p}_{i}^{2} - 1 ) ( {y}_{j}^{2} + {q}_{j}^{2} - 1 ) 〉 \qquad ( 11 )$$

If working with the Gaussian states, then the fourth-order correlations in the Rij can be broke down in the second order correlations using the relation

$$< {X}^{2} {Y}^{2} > = < {X}^{2} > < {Y}^{2 >} + 2 < XY {>}^{2} \qquad ( 12 )$$

Gaussian state: Gaussian state is defined as light mode which can be described completely by specifying the mean and variance of its electric field quadratures. A Gaussian state transforms to a Guassian state through linear optical elements. The optical elements like Beam-splitter, Squeezer, and MZI are linear optical elements.

Each of the term in the last equation can be measured using the balanced homodyne measurements. Hence, the Bell-CHSH inequalities in CV systems can be tested using only balanced homodyne measurements.

Due to the finite number of measurement outcomes and the dark counts on the balanced homodyne detectors, the experiment may not yield the Bell-CHSH violation as it stands. To rectify this problem, the definition of the number operator a†jaj is modified to incorporate the background vacuum fluctuations. The new number operator is defined as (x2j+p2j−x 2vi−p2vi)/2, where x2vi and p2vi are the quadrature operators for the background vacuum. This modification takes care of the vacuum fluctuations that results in the Bell-CHSH violation for appropriate settings.

In reference Thearle et al., PRL 120, 040406 (2018), the authors have shown the Bell-CHSH violation in such CV systems. They used two spatial modes and two polarization modes in order to achieve this violation. Although, this is an important demonstration of the Bell-CHSH violation using CV systems only, the fact that they require polarization modes of light make this demonstration difficult to implement in photonic integrated circuits. This limits its scalability and restrict the applications.

### SUMMARY

The present disclosure relates to a method for generating verifiable quantum random numbers and a system thereof. The present disclosure uses the Continuous Variable (CV) systems and homodyne detection to produce verifiable Quantum Random Numbers Generator (vQRNG). Analog to digital converters create a sequences of random number which can be checked to pass a randomness test. The Bell-CHSH violation is used to ensure the true quantum nature of the obtained random number. To achieve vQRNG using CV systems and homodyne detection, the following steps are implemented:
Step 1: Demonstrating the Bell-CHSH violation for CV systems using homodyne detection.
Step 2: Using the output of the homodyne detectors as random numbers.

In an embodiment, the present disclosure relates to a method for generating verifiable quantum random numbers. The method comprises receiving, by a squeeze operator circuit, four spatial modes (a11, a21, b11, b21) from a source. The four spatial modes (a11, a21, b11, b21) are vacuum modes. Thereafter, the method comprises performing, by the squeeze operator circuit, a squeezing operation on a second mode (a21) of the four spatial modes (a11, a21, b11, b21) in a X-quadrature to produce a X-squeezed vacuum state (a22) and on a third mode (b11) of the four spatial modes (a11, a21, b11, b21) in a P-quadrature to produce a P-squeezed vacuum state (b12). The method comprises interfering, by a balanced beam splitter, the X-squeezed vacuum state (a22) and the P-squeezed vacuum state (b12) to produce an interfered second mode (a23) and an interfered third mode (b13). The method comprises interfering, by the balanced beam splitter, a first mode (a11) of the four spatial modes (a11, a21, b11, b21) with the interfered second mode (a23) and a fourth mode (b21) of the four spatial modes (a11, a21, b11, b21) with the interfered third mode (b13) to produce a new first mode (a14), a new second mode (a24), a new third mode (b14), and a new fourth mode (b24). Thereafter, the method comprises interchanging the new second mode (a24) with the new third mode (b14) and vice-versa to obtain a four-mode Gaussian entangled states (a15, a25, b15, b25). Subsequently, the method comprises performing, by a Mach-Zehnder interferometer, a unitary transformation on a new first mode (a15) and a new second mode (a25) of the four-mode Gaussian entangled states (a15, a25, b15, b25) to produce a transformed first mode (a16) and a transformed second mode (a26) and on a new third mode (b15) and a new fourth mode (b25) of the four-mode Gaussian entangled states (a15, a25, b15, b25) to produce a transformed third mode (b16) and a transformed fourth mode (b26). The method comprises performing, by a plurality of homodyne measurement circuits, homodyne measurements on the transformed first mode (a16) and the transformed second mode (a26) of the four-mode Gaussian entangled states (a16, a26, b16, b26) and on the transformed third mode (b16) and the transformed fourth mode (b26) of the four-mode Gaussian entangled states (a16, a26, b16, b26) to obtain a plurality of analog signals (a1ma, a2ma, b1ma, b2ma). Lastly, the method comprises converting, by a plurality of analog to digital converter circuits, the plurality of analog signals (a1ma, a2ma, b1ma, b2ma) into a plurality of digital signals (a1md, a2md, b1md, b2md) representing sequences of random number and performing a Bell-CSHS inequality check on the plurality of digital signals (a1md, a2md, b1md, b2md) by setting different unitary transformation.

In another embodiment, the present disclosure relates to a method for generating verifiable quantum random numbers. The method comprises receiving, by a squeeze operator circuit, four spatial modes (a11, a21, b11, b21) from a source. The four spatial modes (a11, a21, b11, b21) are vacuum modes. Thereafter, the method comprises performing, by the squeeze operator circuit, a two-mode squeezing operation on a second mode (a21) of the four spatial modes (a11, a21, b11, b21) and on a third mode (b11) of the four spatial modes (a11, a21, b11, b21) to obtain a two-mode squeezed entangled states (a22, b12). The method comprises interfering, by a balanced beam splitter, a first mode (a11) of the four spatial modes (a11, a21, b11, b21) with a squeezed second mode (a22) and a fourth mode (b21) of the four spatial modes (a11, a21, b11, b21) with a squeezed third mode (b12) to produce a new first mode (a13), a new second mode (a23), a new third mode (b13), and a new fourth mode (b23). The method comprises interchanging the new second mode (a23) with the new third mode (b13) and vice-versa to obtain a four-mode Gaussian entangled states (a14, a24, b14, b24). Subsequently, the method comprises performing, by a Mach-Zehnder interferometer, a unitary transformation on a new first mode (a14) and a new second mode (a24) of the four-mode Gaussian entangled states (a14, a24, b14, b24) to produce a transformed first mode (a15) and a transformed second mode (a25) and on a new third mode (b14) and a new fourth mode (b24) of the four-mode Gaussian entangled states (a14, a24, b14, b24) to produce a transformed third mode (b15) and a transformed fourth mode (b25). The method comprises performing, by a plurality of homodyne measurement circuits, homodyne measurements on the transformed first mode (a15) and the transformed second mode (a25) of the four-mode Gaussian entangled states (a15, a25, b15, b25) and on the transformed third mode (b15) and the transformed fourth mode (b25) of the four-mode Gaussian entangled states (a15, a25, b15, b25) to obtain a plurality of analog signals (a1ma, a2ma, b1ma, b2ma). Lastly, the method comprises converting, by a plurality of analog to digital converter circuits, the plurality of analog signals (a1ma, a2ma, b1ma, b2ma) into a plurality of digital signals (a1md, a2md, b1md, b2md) representing sequences of random number, and performing a Bell-CSHS inequality check on the plurality of digital signals (a1md, a2md, b1md, b2md) by setting different unitary transformation.

In an embodiment, the present disclosure relates to a system for generating verifiable quantum random numbers. The system comprises a squeeze operator circuit, a balanced beam splitter, a Mach-Zehnder interferometer, a plurality of homodyne measurement circuits, and a plurality of analog to digital converter circuits. The squeeze operator circuit is configured to receive four spatial modes (a11, a21, b11, b21) from a source, wherein the four spatial modes (a11, a21, b11, b21) are vacuum modes and perform a squeezing operation on a second mode (a21) of the four spatial modes (a11, a21, b11, b21) in a X-quadrature to produce a X-squeezed vacuum state (a22) and on a third mode (b11) of the four spatial modes (a11, a21, b11, b21) in a P-quadrature to produce a P-squeezed vacuum state (b12). The balanced beam splitter is communicatively coupled to the squeeze operator circuit and is configured to interfere the X-squeezed vacuum state (a22) and the P-squeezed vacuum state (b12) to produce an interfered second mode (a23) and an interfered third mode (b13) and interfere a first mode (a11) of the four spatial modes (a11, a21, b11, b21) with the interfered second mode (a23) and a fourth mode (b21) of the four spatial modes (a11, a21, b11, b21) with the interfered third mode (b13) to produce a new first mode (a14), a new second mode (a24), a new third mode (b14), and a new fourth mode (b24). The system is configured to interchange the new second mode (a24) with the new third mode (b14) and vice-versa to obtain a four-mode Gaussian entangled states (a15, a25, b15, b25). The Mach-Zehnder interferometer is communicatively coupled to the balanced beam splitter and is configured to perform a unitary transformation on a new first mode (a15) and a new second mode (a25) of the four-mode Gaussian entangled states (a15, a25, b15, b25) to produce a transformed first mode (a16) and a transformed second mode (a26) and on a new third mode (b15) and a new fourth mode (b25) of the four-mode Gaussian entangled states (a15, a25, b15, b25) to produce a transformed third mode (b16) and a transformed fourth mode (b26). The plurality of homodyne measurement circuits is communicatively coupled to the Mach-Zehnder interferometer and is configured to perform on the transformed first mode (a16) and the transformed second mode (a26) of the four-mode Gaussian entangled states (a16, a26, b16, b26) and on the transformed third mode (b16) and the transformed fourth mode (b26) of the four-mode Gaussian entangled states (a16, a26, b16, b26) to obtain a plurality of analog signals (a1ma, a2ma, b1ma, b2ma). The plurality of analog to digital converter circuits are communicatively coupled to the plurality of homodyne measurement circuits and are configured to convert the plurality of analog signals (a1ma, a2ma, b1ma, b2ma) into a plurality of digital signals (a1md, a2md, b1md, b2md) representing sequences of random number. The system is configured to perform a Bell-CSHS inequality check on the plurality of digital signals (a1md, a2md, b1md, b2md) by setting different unitary transformation.

In another embodiment, the present disclosure relates to a system for generating verifiable quantum random numbers. The system comprises a squeeze operator circuit, a balanced beam splitter, a Mach-Zehnder interferometer, a plurality of homodyne measurement circuits, and a plurality of analog to digital converter circuits. The squeeze operator circuit is configured to receive four spatial modes (a11, a21, b11, b21) from a source, wherein the four spatial modes (a11, a21, b11, b21) are vacuum modes and perform a two-mode squeezing operation on a second mode (a21) of the four spatial modes (a11, a21, b11, b21) and on a third mode (b11) of the four spatial modes (a11, a21, b11, b21) to obtain a two-mode squeezed entangled states (a22, b12). The balanced beam splitter is communicatively coupled to the squeeze operator circuit and is configured to interfere a first mode (a11) of the four spatial modes (a11, a21, b11, b21) with a squeezed second mode (a22) and a fourth mode (b21) of the four spatial modes (a11, a21, b11, b21) with a squeezed third mode (b12) to produce a new first mode (a13), a new second mode (a23), a new third mode (b13), and a new fourth mode (b23). The system is configured to interchange the new second mode (a23) with the new third mode (b13) and vice-versa to obtain a four-mode Gaussian entangled states (a14, a24, b14, b24). The Mach-Zehnder interferometer is communicatively coupled to the balanced beam splitter and is configured to perform a unitary transformation on a new first mode (a14) and a new second mode (a24) of the four-mode Gaussian entangled states (a14, a24, b14, b24) to produce a transformed first mode (a15) and a transformed second mode (a25) and on a new third mode (b14) and a new fourth mode (b24) of the four-mode Gaussian entangled states (a14, a24, b14, b24) to produce a transformed third mode (b15) and a transformed fourth mode (b25). The plurality of homodyne measurement circuits is communicatively coupled to the Mach-Zehnder interferometer and is configured to perform homodyne measurements on the transformed first mode (a15) and the transformed second mode (a25) of the four-mode Gaussian entangled states (a15, a25, b15, b25) and on the transformed third mode (b15) and the transformed fourth mode (b25) of the four-mode Gaussian entangled states (a15, a25, b15, b25) to obtain a plurality of analog signals (a1ma, a2ma, b1ma, b2ma). The plurality of analog to digital converter circuits are communicatively coupled to the plurality of homodyne measurement circuits and are configured to convert the plurality of analog signals (a1ma, a2ma, b1ma, b2ma) into a plurality of digital signals (a1md, a2md, b1md, b2md) representing sequences of random number. The system is configured to perform a Bell-CSHS inequality check on the plurality of digital signals (a1md, a2md, b1md, b2md) by setting different unitary transformation.

Embodiments of the disclosure according to the above-mentioned method, and the system bring about following technical advantages.

The CV implementation of the Bell-CHSH can be performed at room temperature, whereas single-photons that are required for Discrete Variables (DV) implementation require efficient detectors, which in turn requires cryostats. All the non-photonic DV implementations of Bell-CHSH require cryogenic temperature.

The squeezing operations and homodyne measurements in CV systems are more reliable and robust as compared to the entangled photon pair sources and photon number resolving detectors.

The present disclosure uses only spatial modes and does not use polarization or other modes.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1a illustrates a schematic for generating verifiable quantum random numbers for the Bell-CHSH violation in accordance with some embodiments of the present disclosure.

FIG. 1b illustrates a first embodiment for a four-mode entangled state preparation in accordance with some embodiments of the present disclosure.

FIG. 1c illustrates a second embodiment for a four-mode entangled state preparation in accordance with some embodiments of the present disclosure.

FIG. 1d illustrates Mach-Zehnder interferometer in accordance with some embodiments of the present disclosure.

FIG. 2a illustrates a flowchart for generating verifiable quantum random numbers in accordance with first embodiment of the present disclosure.

FIG. 2b illustrates a flowchart for generating verifiable quantum random numbers in accordance with second embodiment of the present disclosure.

FIG. 3 illustrates an experimental set-up for generating and verifying quantum random number in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Squeezing: Squeezing is a quantum mechanical phenomenon whereby the quantum mechanical uncertainty of measurement is reduced.

Squeezing operator: A squeezing operator performs squeezing. In the embodiment of a light pulses, the observable measurement is field quadrature. The field quadrature measurement has variance due to quantum mechanical uncertainty. The squeezing operation reduces variance of quantum mechanical uncertainty in one quadrature which is compensated by increase in uncertainty in the orthogonal quadrature, thereby not violating the quantum uncertainty principle.

In the embodiment of light, a squeezing operation is performed by a non-linear crystal pumped with a laser light. In the absence of input, a quantum mechanical mode of light contains vacuum and shows vacuum fluctuation in measurement of electrical field quadrature. When such vacuum mode is passed through a squeezing circuit, the one of electrical field quadrature shows squeezing. The squeezing quadrature is defined by phase of the pump light.

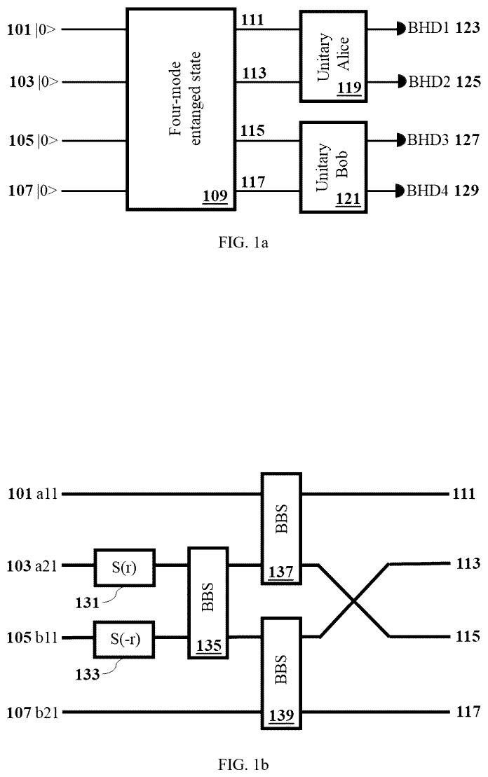

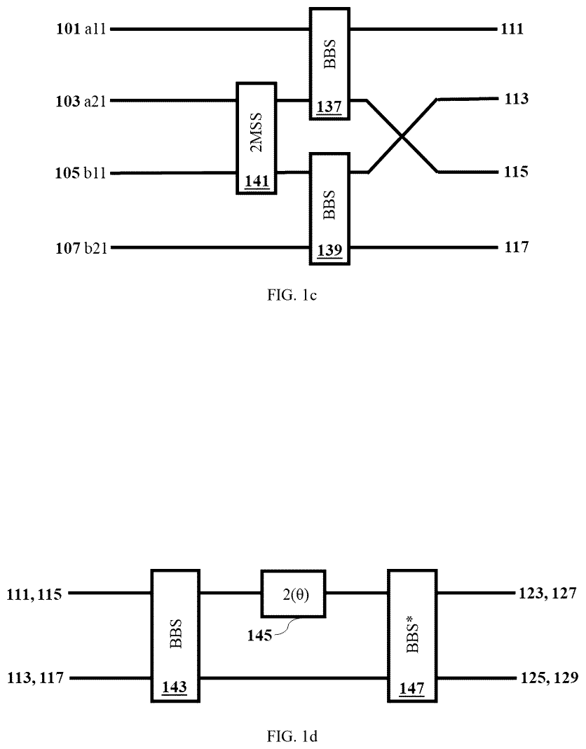

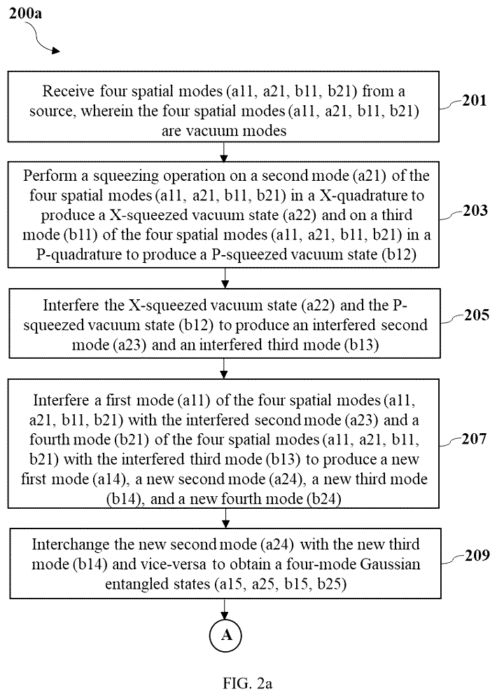

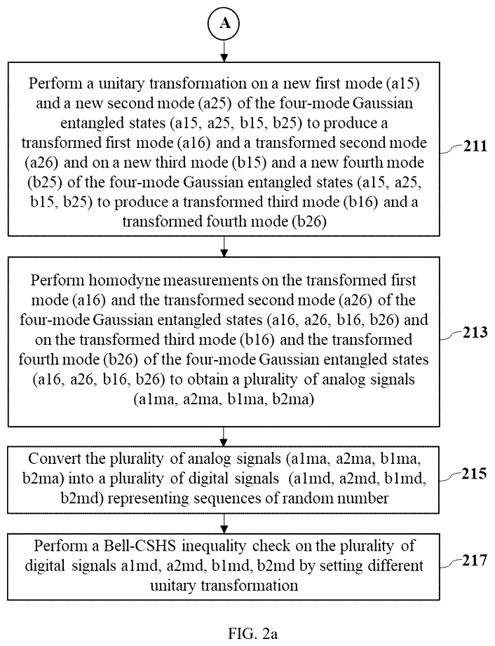

CV Bell violation using the spatial modes only: Although the Bell-CHSH violation in CV systems have been demonstrated using two spatial modes and two polarization modes, this demonstration cannot be scaled to the level of photonic integrated circuits, which is essential for most of the applications such as device independent quantum key distribution and quantum random number generators. In order to achieve this, a Bell-CHSH implementation is disclosed using four spatial modes only. The protocol/method is as follows:
Preparing a four-mode CV entangled state. There is a large class of states which can be used to show the Bell-CHSH violation. The system can be prepared in any of those states. Two of those embodiments or examples are presented in this disclosure.
Sending two spatial modes of the four-mode CV entangled state to Alice and other two spatial modes of the four-mode CV entangled state to Bob.
Alice and Bob performing local unitary transformations on their respective modes using a Mach-Zehnder interferometer.
Alice and Bob performing homodyne measurements in the X and P quadratures on their respective modes and reconciling the measurement results.
Broadly the method or protocol described in the present disclosure can be divided into three main components or portions, as shown in FIG. 1a.
   1. State Preparation 109: Preparation of four-mode entangled state 111, 113, 115, 117.
   2. Local Unitary 119, 121: Unitary transformations performed by Alice 119 and Bob 121 on their respective modes using Mach-Zehnder interferometers (shown in FIG. 1d).
   3. Balanced Homodyne measurements 123, 125, 127, 129: Performing measurements in the four modes and reconciling the measurement outcomes.

Hereinafter, the state preparation, the local unitary and the balanced homodyne measurements are discussed in detail.

State preparation: The general principle behind the four-mode entangled state preparation is as follows: the start is with four spatial modes 101, 103, 105, 107 in vacuum state. Using squeezing operations, displacement operations, beam splitters and phase shifters, a four-mode entanglement is prepared. In the present disclosure, only CV Gaussian states are considered. Therefore, these operations are sufficient to prepare all the desired states. However, the Quantum Random Number Generator (QRNG) protocol or method presented here is not limited to CV Gaussian states. In fact, a large class of four-mode non-classical optical state can be used in using method presented in the present disclosure. Here two specific embodiments or examples of four-mode entangled state preparation are discussed.

First embodiment or Example 1: In this embodiment, for four-mode entangled state preparation, the four spatial modes a11, a21, b11, b21 are considered to be in vacuum state (see FIG. 1b). Mode a21 and b11 are squeezed with squeezing operator S(r) 131 and S(−r) 133, respectively. Here r is the squeezing parameter. Hence, a21 is squeezed in the X-quadrature and b11 is squeezed in the P-quadrature. These two modes a22, b12 are interfered on a Balanced Beam Slitter (BBS) 135. Mode a11 and a23 are interfered on BBS 137 and b13 and b21 are interfered on BBS 139. Afterwards, the mode a24 and b14 are crossed to obtain a four-mode Gaussian entangled states a15, a25, b15, b25. This prepares a four-mode Gaussian entangled state a15, a25, b15, b25. Note that the BBS used in this embodiment is just to achieve a particular state. One can use other methods and other beam splitters to generate a four-mode Gaussian entangled state.

With reference to the first embodiment, the preparation of the four-mode Gaussian entangled state a15, a25, b15, b25 is explained in detail below.

A squeeze operator circuit receives four spatial modes a11, a21, b11, b21 (references 101, 103, 105, 107, respectively, shown in FIG. 1b) from a source. The four spatial modes a11, a21, b11, b21 are vacuum modes. The source could be any experimental set-up that prepares four spatial modes a11, a21, b11, b21. Thereafter, the squeeze operator circuit 131, 133 performs a squeezing operation on a second mode a21 of the four spatial modes a11, a21, b11, b21 in a X-quadrature to produce a X-squeezed vacuum state a22 and on a third mode b11 of the four spatial modes a11, a21, b11, b21 in a P-quadrature to produce a P-squeezed vacuum state b12.

The squeezing operation is performed by a non-linear medium with a plurality of vacuum input and pumped with a laser light. A squeezed vacuum state refers to a state of light with a reduced quantum uncertainty in its electric field strength for some phases compared to a vacuum state. The X-quadrature and the P-quadrature are orthogonal quadratures of an electric field of a light mode. Subsequently, a balanced beam splitter 135 interferes the X-squeezed vacuum state a22 and the P-squeezed vacuum state b12 to produce an interfered second mode a23 and an interfered third mode b13. The balanced beam splitter 137 interferes a first mode a11 of the four spatial modes a11, a21, b11, b21 with the interfered second mode a23 and the balanced beam splitter 139 interferes a fourth mode b21 of the four spatial modes a11, a21, b11, b21 with the interfered third mode b13 to produce a new first mode a14, a new second mode a24, a new third mode b14, and a new fourth mode b24. The new second mode a24 is interchanged with the new third mode b14 and vice-versa to obtain a four-mode Gaussian entangled states a15, a25, b15, b25 (references 111, 113, 115, 117, respectively, shown in FIG. 1b).

Second embodiment or Example 2: In this embodiment, for four-mode entangled state preparation, the four spatial modes a11, a21, b11, b21 are considered to be in vacuum state (see FIG. 1c). Mode a21 and b11 are squeezed to obtain a two-mode squeezed entangled states a22, b12. a11 and a22 are interfered on a BBS 137 and b12 and b21 on another BBS 139. Finally, a23 and b13 are crossed in order to get four-mode entangled states to obtain a four-mode Gaussian entangled states a14, a24, b14, b24. Note that the BBS used in this embodiment is to achieve a particular state. One can use other methods and other beam splitters to generate a four-mode Gaussian entangled state.

With reference to the second embodiment, the preparation of the four-mode Gaussian entangled state a14, a24, b14, b24 is explained in detail below.

A squeeze operator circuit receives four spatial modes a11, a21, b11, b21 (references 101, 103, 105, 107, respectively, shown in FIG. 1c) from a source. The four spatial modes a11, a21, b11, b21 are vacuum modes. The source could be any experimental set-up that prepares four spatial modes a11, a21, b11, b21. Thereafter, the squeeze operator circuit (also, referred as two-mode squeezed states, 2MSS) 141 performs a two-mode squeezing operation on a second mode a21 of the four spatial modes a11, a21, b11, b21 and on a third mode b11 of the four spatial modes a11, a21, b11, b21 to obtain a two-mode squeezed entangled states a22, b12. The two-mode squeezing operation is performed by a non-linear medium with a plurality of vacuum input and pumped with a laser light. A two-mode squeezed entangled states or squeezed vacuum state refers to a state of light with a reduced quantum uncertainty in its electric field strength for some phases compared to a vacuum state. Subsequently, a balanced beam splitter 137 interferes a first mode a11 of the four spatial modes a11, a21, b11, b21 with a squeezed second mode a22 and the balanced beam splitter 139 interferes a fourth mode b21 of the four spatial modes a11, a21, b11, b21 with a squeezed third mode b12 to produce a new first mode a13, a new second mode a23, a new third mode b13, and a new fourth mode b23. The new second mode a23 is interchanged with the new third mode b13 and vice-versa to obtain a four-mode Gaussian entangled states a14, a24, b14, b24 (references 111, 113, 115, 117, respectively, shown in FIG. 1c).

Local Unitary: After preparing the four-mode entangled state, Alice 119 and Bob 121 needs to preform unitary transformations to mix their respective spatial modes. This is achieved by Mach-Zehnder interferometers (MZI). Here, the aim is to prepare a±(θ1) (i.e., a transformed first mode a16 and a transformed second mode a26 for the first embodiment, and a transformed first mode a15 and a transformed second mode a25 for the second embodiment, description below) and b±(θ2) (i.e., a transformed third mode b16 and a transformed fourth mode b26 for the first embodiment, and a transformed third mode b15 and a transformed fourth mode b25 for the second embodiment, description below) modes which are given by

$$\begin{matrix}{a}_{+} ( {θ}_{1} ) = cos {θ}_{1} {a}_{1} + \\ sin {θ}_{1} {a}_{2} , ;\end{matrix} {a}_{-} ( {θ}_{2} ) = cos {θ}_{2} {a}_{2} - sin {θ}_{2} {a}_{1} , \qquad ( 13 )$$

$$\begin{matrix}{b}_{+} ( {θ}_{2} ) = cos {θ}_{2} {b}_{1} + \\ sin {θ}_{2} {b}_{2} , ;\end{matrix} {b}_{-} ( {θ}_{2} ) = cos {θ}_{2} {b}_{2} - sin {θ}_{2} {b}_{1} \qquad ( 14 )$$

MZI: Mach-Zehnder interferometer consists of two BBS 143, 147 and one phase shifter (2(θ)) 145 (as shown in FIG. 1d). The mathematics for the MZI is as follows:
The 2×2 matrix representation of a BBS is

$${B}_{\text{?}} = \frac{1}{\sqrt{2}} ( \begin{matrix}1 & i \\ i & 1\end{matrix} )$$

$$\text{?} \text{indicates text missing or illegible when filed}$$

The MZI in FIG. 1d results in the transformation matrix

$$\frac{1}{\sqrt{2}} ( \begin{matrix}1 & i \\ i & 1\end{matrix} ) ( \begin{matrix}exp ( i 2 θ ) & \\ & 1\end{matrix} ) \frac{1}{\sqrt{2}} ( \begin{matrix}1 & - i \\ - i & 1\end{matrix} ) = exp ( i θ ) ( \begin{matrix}cos θ & sin θ \\ - sin θ & cos θ\end{matrix} )$$

In this particular decomposition of MZI, a specific form of BBS is used. However, the decomposition of MZI is not unique and not limited to this particular BBS.

With reference to the first embodiment, the unitary transformations performed by Alice 119 and Bob 121 on their respective modes using Mach-Zehnder interferometers (shown in FIGS. 1a and 1d) are explained in detail below.

The Mach-Zehnder interferometer (reference Unitary Alice 119 in FIG. 1a) performs a unitary transformation on a new first mode a15 and a new second mode a25 of the four-mode Gaussian entangled states a15, a25, b15, b25 to produce a transformed first mode a16 and a transformed second mode a26. Analogously, the Mach-Zehnder interferometer (reference Unitary Bob 121 in FIG. 1a) performs a unitary transformation on a new third mode b15 and a new fourth mode b25 of the four-mode Gaussian entangled states a15, a25, b15, b25 to produce a transformed third mode b16 and a transformed fourth mode b26.

With reference to the second embodiment, the unitary transformations performed by Alice 119 and Bob 121 on their respective modes using Mach-Zehnder interferometers (shown in FIGS. 1a and 1d) are explained in detail below.

The Mach-Zehnder interferometer (reference Unitary Alice 119 in FIG. 1a) performs a unitary transformation on a new first mode a14 and a new second mode a24 of the four-mode Gaussian entangled states a14, a24, b14, b24 to produce a transformed first mode a15 and a transformed second mode a25. Analogously, the Mach-Zehnder interferometer (reference Unitary Bob 121 in FIG. 1a) performs a unitary transformation on a new third mode b14 and a new fourth mode b24 of the four-mode Gaussian entangled states a14, a24, b14, b24 to produce a transformed third mode b15 and a transformed fourth mode b25.

Balanced Homodyne measurements: In order to demonstrate the violation of Bell-CHSH inequality, the a±(θ1) (i.e., a transformed first mode a16 and a transformed second mode a26 for the first embodiment, and a transformed first mode a15 and a transformed second mode a25 for the second embodiment) and b±(θ2) (i.e., a transformed third mode b16 and a transformed fourth mode b26 for the first embodiment, and a transformed third mode b15 and a transformed fourth mode b25 for the second embodiment) modes need to be measured and the intensity-intensity correlation is to acquired, which is given by

$${R}^{i j} ( {θ}_{1} , {θ}_{2} ) = < {a}_{i}^{†} ( {θ}_{1} ) {a}_{i} ( {θ}_{1} ) {b}_{i}^{†} ( {θ}_{2} ) {b}_{i} ( {θ}_{2} ) > . \qquad ( 15 )$$

Here i, j∈{±}. This intensity-intensity correlation function R^{ij} is related to the expectation value E(θ₁, θ₂) given by

$$E ( {θ}_{1} , {θ}_{2} ) = \frac{{R}^{++} ( {θ}_{1} , {θ}_{2} ) - {R}^{+ -} ( {θ}_{1} , {θ}_{2} ) - {R}^{- +} ( {θ}_{1} , {θ}_{2} ) + {R}^{--} ( {θ}_{1} , {θ}_{2} )}{{R}^{++} ( {θ}_{1} , {θ}_{2} ) + {R}^{+ -} ( {θ}_{1} , {θ}_{2} ) + {R}^{- +} ( {θ}_{1} , {θ}_{2} ) + {R}^{--} ( {θ}_{1} , {θ}_{2} )} \qquad ( 16 )$$

In order to show the Bell-CHSH violation in CV systems, a four-mode entangled state |ψ> and four parameters θ_{A}, φ_{A} and θ_{B}, φ_{B} is needed such that

$$\vert E ( {θ}_{A} , {θ}_{B} ) + E ( {θ}_{A} , {φ}_{B} ) + E ( {φ}_{A} , {θ}_{B} ) - E ( {φ}_{A} , {φ}_{B} ) \vert > 2. \qquad ( 17 )$$

Due to the finite number of measurement outcomes and the dark counts on the detectors, the experiment may not yield a Bell-CHSH violation as it stands. To rectify this problem, the definition of the number operator a†ⱼaⱼ is modified to incorporate the background vacuum fluctuations. The new number operator is defined as (x²ⱼ+p²ⱼ−x²ᵥᵢ−p²ᵥᵢ)/2, where x²ᵥᵢ and p²ᵥᵢ are the quadrature operators for the background vacuum. This modification takes care of the vacuum fluctuations that results in a Bell violation for appropriate settings.

### Converting Intensity-Intensity Correlations Into Quadrature Measurements:

The quadratures operators xᵢ, yᵢ, pⱼ, qⱼ and the field operators aᵢ, bᵢ are related as

$${x}_{j} = ( {a}_{j} + {a}_{j}^{†} ) / \sqrt{2} ; {p}_{j} = i ( {a}_{j} + {a}_{j}^{†} ) / \sqrt{2} \qquad ( 18 )$$

$${y}_{j} ( {b}_{j} + {b}_{j}^{†} ) / \sqrt{2} ; {q}_{j} = i ( {b}_{j} + {b}_{j}^{†} ) / \sqrt{2} , \qquad ( 19 )$$

and the number operator a†jaj−a†vjavj=(x2j+p2j−x 2vi−p2vi)/2, where avj is the annihilation operator of the background vacuum and x2vi and p2vi are the quadrature operators for the background vacuum. Similarly, the operators a±(θ) and b±(φ) can also be expressed in terms of quadrature operators.

Hence, in the expression of Rij(θA, θB) the field operators with the quadrature operators can be replaced as

$${R}^{ij} = \frac{1}{4} 〈 ( {x}_{i}^{2} + {p}_{i}^{2} - {x}_{vi}^{2} - {p}_{vi}^{2} ) ( {y}_{j}^{2} + {q}_{j}^{2} - {y}_{vj}^{2} - {q}_{vj}^{2} ) 〉 \qquad ( 20 )$$

If the Gaussian states are considered, then the fourth-order correlations in the R^{ij} can be broke down in the second order correlations using the relation

$$< {X}^{2} {Y}^{2} > = < {X}^{2} > < {Y}^{2} > + 2 < XY {>}^{2} . \qquad ( 21 )$$

Hence, performing correlated homodyne measurement in the X- and P-quadratures on Alice's and Bob's modes and yield the Bell-CHSH violation.

With reference to the first embodiment, the correlated homodyne measurement performed in the X- and P-quadratures on Alice's and Bob's modes (shown in FIG. 1a) is explained in detail below.

A plurality of homodyne measurement circuits BHD1, BHD2 perform homodyne measurements on the transformed first mode a16 and the transformed second mode a26 of the four-mode Gaussian entangled states a16, a26, b16, b26 to obtain a plurality of analog signals a1ma, a2ma (references 123, 125, respectively, in FIG. 1a). Analogously, the plurality of homodyne measurement circuits BHD3, BHD4 perform homodyne measurements on the transformed third mode b16 and the transformed fourth mode b26 of the four-mode Gaussian entangled states a16, a26, b16, b26 to obtain a plurality of analog signals b1ma, b2ma (references 127, 129, respectively, in FIG. 1a). The homodyne measurements on the four-mode Gaussian entangled states a16, a26, b16, b26 are performed in a combination of X-quadratures and P-quadratures.

With reference to the second embodiment, the correlated homodyne measurement performed in the X- and P-quadratures on Alice's and Bob's modes (shown in FIG. 1a) is explained in detail below.

A plurality of homodyne measurement circuits BHD1, BHD2 perform homodyne measurements on the transformed first mode a15 and the transformed second mode a25 of the four-mode Gaussian entangled states a15, a25, b15, b25 to obtain a plurality of analog signals a1ma, a2ma (references 123, 125, respectively, in FIG. 1a). Analogously, the plurality of homodyne measurement circuits BHD3, BHD4 perform homodyne measurements on the transformed third mode b15 and the transformed fourth mode b25 of the four-mode Gaussian entangled states a15, a25, b15, b25 to obtain a plurality of analog signals b1ma, b2ma (references 127, 129, respectively, in FIG. 1a). The homodyne measurements on the four-mode Gaussian entangled states a15, a25, b15, b25 are performed in a combination of X-quadratures and P-quadratures.

With reference to the first embodiment and the second embodiment, a plurality of analog to digital converter circuits (not shown in FIG. 1a)convert the plurality of analog signals a1ma, a2ma, b1ma, b2ma into a plurality of digital signals a1md, a2md, b1md, b2md, respectively, representing sequences of random number. Each of plurality of digital signals a1md, a2md, b1md, b2md represents a random number. In an embodiment, the plurality of digital signals a1md, a2md, b1md, b2md are used to verify if the equation 17 is satisfied in order to show the Bell-CHSH violation. The system is configured to perform a Bell-CSHS inequality check on the plurality of digital signals (a1md, a2md, b1md, b2md) by setting different unitary transformation. Not limiting to the plurality of digital signals a1md, a2md, b1md, b2md for verifying if the equation 17 is satisfied in order to show the Bell-CHSH violation, the plurality of analog signals a1ma, a2ma, b1ma, b2ma can also be used to verify if the equation 17 is satisfied in order to show the Bell-CHSH violation.

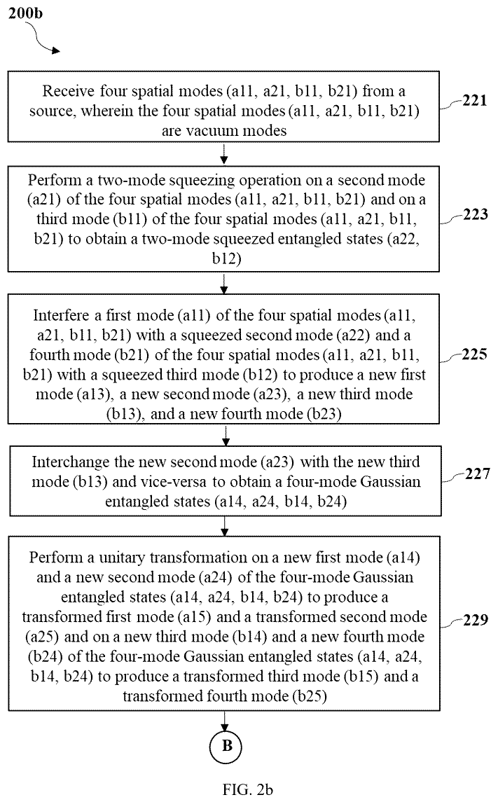

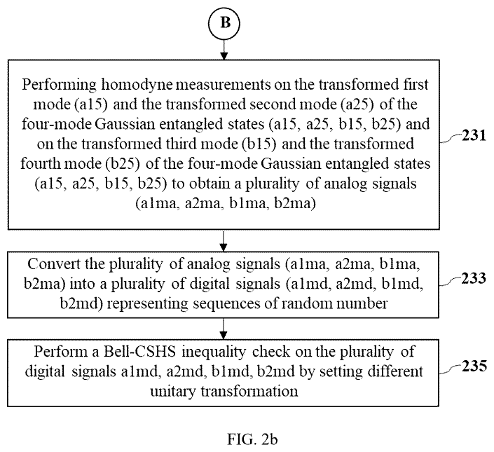

FIG. 2a illustrates a flowchart for generating verifiable quantum random numbers in accordance with first embodiment of the present disclosure.

As illustrated in FIG. 2a, the method 200a includes one or more blocks for generating verifiable quantum random numbers. The method 200a may be described in the general context of computer executable instructions. Generally, computer executable instructions can include routines, programs, objects, components, data structures, procedures, modules, and functions, which perform particular functions or implement particular abstract data types.

The order in which the method 200a is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 201, a squeeze operator circuit receives four spatial modes a11, a21, b11, b21 from a source. The four spatial modes a11, a21, b11, b21 are vacuum modes.

At block 203, the squeeze operator circuit performs a squeezing operation on a second mode a21 of the four spatial modes a11, a21, b11, b21 in a X-quadrature to produce a X-squeezed vacuum state a22 and on a third mode b11 of the four spatial modes a11, a21, b11, b21 in a P-quadrature to produce a P-squeezed vacuum state b12. The squeezing operation is performed by a non-linear medium with a plurality of vacuum input and pumped with a laser light. The X-quadrature and the P-quadrature are orthogonal quadratures of an electric field of a light mode.

At block 205, a balanced beam splitter interferes the X-squeezed vacuum state a22 and the P-squeezed vacuum state b12 to produce an interfered second mode a23 and an interfered third mode b13. A squeezed vacuum state refers to a state of light with a reduced quantum uncertainty in its electric field strength for some phases compared to a vacuum state. The balanced beam splitter is communicatively coupled to the squeeze operator circuit.

At block 207, the balanced beam splitter interferes a first mode a11 of the four spatial modes a11, a21, b11, b21 with the interfered second mode a23 and a fourth mode b21 of the four spatial modes a11, a21, b11, b21 with the interfered third mode b13 to produce a new first mode a14, a new second mode a24, a new third mode b14, and a new fourth mode b24.

At block 209, the system interchanges the new second mode a24 with the new third mode b14 and vice-versa to obtain a four-mode Gaussian entangled states a15, a25, b15, b25.

At block 211, a Mach-Zehnder interferometer performs a unitary transformation on a new first mode a15 and a new second mode a25 of the four-mode Gaussian entangled states a15, a25, b15, b25 to produce a transformed first mode a16 and a transformed second mode a26 and on a new third mode b15 and a new fourth mode b25 of the four-mode Gaussian entangled states a15, a25, b15, b25 to produce a transformed third mode b16 and a transformed fourth mode b26. The Mach-Zehnder interferometer (MZI) is communicatively coupled to the balanced beam splitter.

At block 213, a plurality of homodyne measurement circuits performs homodyne measurements on the transformed first mode a16 and the transformed second mode a26 of the four-mode Gaussian entangled states a16, a26, b16, b26 and on the transformed third mode b16 and the transformed fourth mode b26 of the four-mode Gaussian entangled states a16, a26, b16, b26 to obtain a plurality of analog signals a1ma, a2ma, b1ma, b2ma. The homodyne measurements on the four-mode Gaussian entangled states a16, a26, b16, b26 are performed in a combination of X-quadratures and P-quadratures. The plurality of homodyne measurement circuits is communicatively coupled to the Mach-Zehnder interferometer.

At block 215, a plurality of analog to digital converter circuits converts the plurality of analog signals a1ma, a2ma, b1ma, b2ma into a plurality of digital signals a1md, a2md, b1md, b2md representing sequences of random number. The plurality of analog to digital converter circuits is communicatively coupled to the plurality of homodyne measurement circuits.

At block 217, the system is configured to perform a Bell-CSHS inequality check on the plurality of digital signals a1md, a2md, b1md, b2md by setting different unitary transformation.

FIG. 2b illustrates a flowchart for generating verifiable quantum random numbers in accordance with second embodiment of the present disclosure.

As illustrated in FIG. 2b, the method 200b includes one or more blocks for generating verifiable quantum random numbers. The method 200b may be described in the general context of computer executable instructions. Generally, computer executable instructions can include routines, programs, objects, components, data structures, procedures, modules, and functions, which perform particular functions or implement particular abstract data types.

The order in which the method 200b is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 221, a squeeze operator circuit receives four spatial modes a11, a21, b11, b21 from a source. The four spatial modes a11, a21, b11, b21 are vacuum modes.

At block 223, the squeeze operator circuit performs a two-mode squeezing operation on a second mode a21 of the four spatial modes a11, a21, b11, b21 and on a third mode b11 of the four spatial modes a11, a21, b11, b21 to obtain a two-mode squeezed entangled states a22, b12. The two-mode squeezing operation is performed by a non-linear medium with a plurality of vacuum input and pumped with a laser light. The squeezed entangled states or squeezed vacuum state refers to a state of light with a reduced quantum uncertainty in its electric field strength for some phases compared to a vacuum state.

At block 225, a balanced beam splitter interferes a first mode a11 of the four spatial modes a11, a21, b11, b21 with a squeezed second mode a22 and a fourth mode b21 of the four spatial modes a11, a21, b11, b21 with a squeezed third mode b12 to produce a new first mode a13, a new second mode a23, a new third mode b13, and a new fourth mode b23. The balanced beam splitter is communicatively coupled to the squeeze operator circuit.

At block 227, the system interchange the new second mode a23 with the new third mode b13 and vice-versa to obtain a four-mode Gaussian entangled states a14, a24, b14, b24.

At block 229, a Mach-Zehnder interferometer performs a unitary transformation on a new first mode a14 and a new second mode a24 of the four-mode Gaussian entangled states a14, a24, b14, b24 to produce a transformed first mode a15 and a transformed second mode a25 and on a new third mode b14 and a new fourth mode b24 of the four-mode Gaussian entangled states a14, a24, b14, b24 to produce a transformed third mode b15 and a transformed fourth mode b25. The Mach-Zehnder interferometer is communicatively coupled to the balanced beam splitter.

At block 231, a plurality of homodyne measurement circuits performs homodyne measurements on the transformed first mode a15 and the transformed second mode a25 of the four-mode Gaussian entangled states a15, a25, b15, b25 and on the transformed third mode b15 and the transformed fourth mode b25 of the four-mode Gaussian entangled states a15, a25, b15, b25 to obtain a plurality of analog signals a1ma, a2ma, b1ma, b2ma. The homodyne measurements on the four-mode Gaussian entangled states a16, a26, b16, b26 are performed in a combination of X-quadratures and P-quadratures. The plurality of homodyne measurement circuits is communicatively coupled to the Mach-Zehnder interferometer.

At block 233, a plurality of analog to digital converter circuits converts the plurality of analog signals a1ma, a2ma, b1ma, b2ma into a plurality of digital signals a1md, a2md, b1md, b2md representing sequences of random number. The plurality of analog to digital converter circuits is communicatively coupled to the plurality of homodyne measurement circuits.

At block 235, the system is configured to perform a Bell-CSHS inequality check on the plurality of digital signals a1md, a2md, b1md, b2md by setting different unitary transformation.

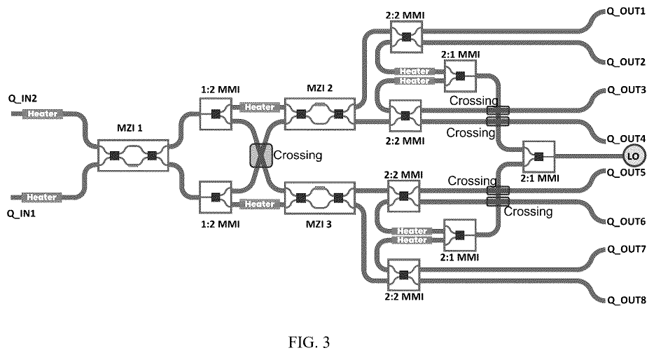

FIG. 3 illustrates a system or an experimental set-up for generating and verifying quantum random number in accordance with some embodiments of the present disclosure.

The experimental set-up for generating and verifying quantum random number is shown in FIG. 3 and its corresponding schematic is shown in FIG. 1a. The operation of the system or the experimental setup as shown in FIG. 3 would be understood by a person skilled in the art in combination with the description (mentioned above) associated with the FIGS. 1a to 1d and FIGS. 2a to 2b.

The system or experimental set-up includes a plurality of components. These components include squeezed light source (not shown in FIG. 3), one or more heaters to perform phase shifts, one or more Mach-Zehnder Interferometers (MZI) for unitary operations, one or more multi-mode interferometers (MMI) (i.e., balanced beam splitters) to perform beam-splitter action, one or more crossings for interchange operation, a Local Oscillator (LO) to perform homodyne measurements, a plurality of homodyne measurement circuits (not shown in FIG. 3) and a plurality of analog to digital converter circuits (not shown in FIG. 3).

Some of the technical advantages of the present disclosure are listed below.

The CV implementation of the Bell-CHSH can be performed at room temperature, whereas single-photons that are required for Discrete Variables (DV) implementation require efficient detectors, which in turn requires cryostats. All the non-photonic DV implementations of Bell-CHSH require cryogenic temperature.

The squeezing operations and homodyne measurements in CV systems are more reliable and robust as compared to the entangled photon pair sources and photon number resolving detectors.

The present disclosure uses only spatial modes and does not use polarization or other modes.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 2a and 2b show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the scope being indicated by the following claims.

We claim:

1. A method for generating verifiable quantum random numbers, the method comprising:
receiving, by a squeeze operator circuit, four spatial modes (a11, a21, b11, b21) from a source, wherein the four spatial modes (a11, a21, b11, b21) are vacuum modes;
performing, by the squeeze operator circuit, a squeezing operation on a second mode (a21) of the four spatial modes (a11, a21, b11, b21) in a X-quadrature to produce a X-squeezed vacuum state (a22) and on a third mode (b11) of the four spatial modes (a11, a21, b11, b21) in a P-quadrature to produce a P-squeezed vacuum state (b12);
interfering, by a balanced beam splitter, the X-squeezed vacuum state (a22) and the P-squeezed vacuum state (b12) to produce an interfered second mode (a23) and an interfered third mode (b13);
interfering, by the balanced beam splitter, a first mode (a11) of the four spatial modes (a11, a21, b11, b21) with the interfered second mode (a23) and a fourth mode (b21) of the four spatial modes (a11, a21, b11, b21) with the interfered third mode (b13) to produce a new first mode (a14), a new second mode (a24), a new third mode (b14), and a new fourth mode (b24);
interchanging the new second mode (a24) with the new third mode (b14) and vice-versa to obtain a four-mode Gaussian entangled states (a15, a25, b15, b25);
performing, by a Mach-Zehnder interferometer, a unitary transformation on a new first mode (a15) and a new second mode (a25) of the four-mode Gaussian entangled states (a15, a25, b15, b25) to produce a transformed first mode (a16) and a transformed second mode (a26) and on a new third mode (b15) and a new fourth mode (b25) of the four-mode Gaussian entangled states (a15, a25, b15, b25) to produce a transformed third mode (b16) and a transformed fourth mode (b26);
performing, by a plurality of homodyne measurement circuits, homodyne measurements on the transformed first mode (a16) and the transformed second mode (a26) of the four-mode Gaussian entangled states (a16, a26, b16, b26) and on the transformed third mode (b16) and the transformed fourth mode (b26) of the four-mode Gaussian entangled states (a16, a26, b16, b26) to obtain a plurality of analog signals (a1ma, a2ma, b1ma, b2ma); and
converting, by a plurality of analog to digital converter circuits, the plurality of analog signals (a1ma, a2ma, b1ma, b2ma) into a plurality of digital signals (a1md, a2md, b1md, b2md) representing sequences of random number; and
performing, a Bell-CSHS inequality check on the plurality of digital signals (a1md, a2md, b1md, b2md) by setting different unitary transformation.

2. The method as claimed in claim 1, wherein the squeezing operation is performed by a non-linear medium with a plurality of vacuum input and pumped with a laser light.

3. The method as claimed in claim 1, wherein the homodyne measurements on the four-mode Gaussian entangled states (a16, a26, b16, b26) are performed in a combination of X-quadratures and P-quadratures.

4. The method as claimed in claim 1, wherein a squeezed vacuum state refers to a state of light with a reduced quantum uncertainty in its electric field strength for some phases compared to a vacuum state.

5. The method as claimed in claim 1, wherein the X-quadrature and the P-quadrature are orthogonal quadratures of an electric field of a light mode.

6. A method for generating verifiable quantum random numbers, the method comprising:
receiving, by a squeeze operator circuit, four spatial modes (a11, a21, b11, b21) from a source, wherein the four spatial modes (a11, a21, b11, b21) are vacuum modes;
performing, by the squeeze operator circuit, a two-mode squeezing operation on a second mode (a21) of the four spatial modes (a11, a21, b11, b21) and on a third mode (b11) of the four spatial modes (a11, a21, b11, b21) to obtain a two-mode squeezed entangled states (a22, b12);
interfering, by a balanced beam splitter, a first mode (a11) of the four spatial modes (a11, a21, b11, b21) with a squeezed second mode (a22) and a fourth mode (b21) of the four spatial modes (a11, a21, b11, b21) with a squeezed third mode (b12) to produce a new first mode (a13), a new second mode (a23), a new third mode (b13), and a new fourth mode (b23);
interchanging the new second mode (a23) with the new third mode (b13) and vice-versa to obtain a four-mode Gaussian entangled states (a14, a24, b14, b24);
performing, by a Mach-Zehnder interferometer, a unitary transformation on a new first mode (a14) and a new second mode (a24) of the four-mode Gaussian entangled states (a14, a24, b14, b24) to produce a transformed first mode (a15) and a transformed second mode (a25) and on a new third mode (b14) and a new fourth mode (b24) of the four-mode Gaussian entangled states (a14, a24, b14, b24) to produce a transformed third mode (b15) and a transformed fourth mode (b25);
performing, by a plurality of homodyne measurement circuits, homodyne measurements on the transformed first mode (a15) and the transformed second mode (a25) of the four-mode Gaussian entangled states (a15, a25, b15, b25) and on the transformed third mode (b15) and the transformed fourth mode (b25) of the four-mode Gaussian entangled states (a15, a25, b15, b25) to obtain a plurality of analog signals (a1ma, a2ma, b1ma, b2ma);
converting, by a plurality of analog to digital converter circuits, the plurality of analog signals (a1ma, a2ma, b1ma, b2ma) into a plurality of digital signals (a1md, a2md, b1md, b2md) representing sequences of random number; and
performing, a Bell-CSHS inequality check on the plurality of digital signals (a1md, a2md, b1md, b2md) by setting different unitary transformation.

7. The method as claimed in claim 6, wherein the two-mode squeezing operation is performed by a non-linear medium with a plurality of vacuum input and pumped with a laser light.

8. The method as claimed in claim 6, wherein the homodyne measurements on the four-mode Gaussian entangled states (a15, a25, b15, b25) are performed in a combination of X-quadratures and P-quadratures.

9. The method as claimed in claim 6, wherein a squeezed vacuum state refers to a state of light with a reduced quantum uncertainty in its electric field strength for some phases compared to a vacuum state.

10. A system for generating verifiable quantum random numbers, the system comprising:
a squeeze operator circuit configured to:
receive four spatial modes (a11, a21, b11, b21) from a source, wherein the four spatial modes (a11, a21, b11, b21) are vacuum modes;
perform a squeezing operation on a second mode (a21) of the four spatial modes (a11, a21, b11, b21) in a X-quadrature to produce a X-squeezed vacuum state (a22) and on a third mode (b11) of the four spatial modes (a11, a21, b11, b21) in a P-quadrature to produce a P-squeezed vacuum state (b12);
a balanced beam splitter communicatively coupled to the squeeze operator circuit and configured to:
interfere the X-squeezed vacuum state (a22) and the P-squeezed vacuum state (b12) to produce an interfered second mode (a23) and an interfered third mode (b13);
interfere a first mode (a11) of the four spatial modes (a11, a21, b11, b21) with the interfered second mode (a23) and a fourth mode (b21) of the four spatial modes (a11, a21, b11, b21) with the interfered third mode (b13) to produce a new first mode (a14), a new second mode (a24), a new third mode (b14), and a new fourth mode (b24);
interchange the new second mode (a24) with the new third mode (b14) and vice-versa to obtain a four-mode Gaussian entangled states (a15, a25, b15, b25);
a Mach-Zehnder interferometer communicatively coupled to the balanced beam splitter and configured to:
perform a unitary transformation on a new first mode (a15) and a new second mode (a25) of the four-mode Gaussian entangled states (a15, a25, b15, b25) to produce a transformed first mode (a16) and a transformed second mode (a26) and on a new third mode (b15) and a new fourth mode (b25) of the four-mode Gaussian entangled states (a15, a25, b15, b25) to produce a transformed third mode (b16) and a transformed fourth mode (b26);
a plurality of homodyne measurement circuits communicatively coupled to the Mach-Zehnder interferometer and configured to:
perform on the transformed first mode (a16) and the transformed second mode (a26) of the four-mode Gaussian entangled states (a16, a26, b16, b26) and on the transformed third mode (b16) and the transformed fourth mode (b26) of the four-mode Gaussian entangled states (a16, a26, b16, b26) to obtain a plurality of analog signals (a1ma, a2ma, b1ma, b2ma);
a plurality of analog to digital converter circuits communicatively coupled to the plurality of homodyne measurement circuits and configured to:
convert the plurality of analog signals (a1ma, a2ma, b1ma, b2ma) into a plurality of digital signals (a1md, a2md, b1md, b2md) representing sequences of random number; and
perform a Bell-CSHS inequality check on the plurality of digital signals (a1md, a2md, b1md, b2md) by setting different unitary transformation.

11. The system as claimed in claim 10, wherein the squeezing operation is performed by a non-linear medium with a plurality of vacuum input and pumped with a laser light.

12. The system as claimed in claim 10, wherein the homodyne measurements on the four-mode Gaussian entangled states (a16, a26, b16, b26) are performed in a combination of X-quadratures and P-quadratures.

13. The system as claimed in claim 10, wherein a squeezed vacuum state refers to a state of light with a reduced quantum uncertainty in its electric field strength for some phases compared to a vacuum state.

14. The system as claimed in claim 10, wherein the X-quadrature and the P-quadrature are orthogonal quadratures of an electric field of a light mode.

15. A system for generating verifiable quantum random numbers, the system comprising:
a squeeze operator circuit configured to:
receive four spatial modes (a11, a21, b11, b21) from a source, wherein the four spatial modes (a11, a21, b11, b21) are vacuum modes;
perform a two-mode squeezing operation on a second mode (a21) of the four spatial modes (a11, a21, b11, b21) and on a third mode (b11) of the four spatial modes (a11, a21, b11, b21) to obtain a two-mode squeezed entangled states (a22, b12);
a balanced beam splitter communicatively coupled to the squeeze operator circuit and configured to:
interfere a first mode (a11) of the four spatial modes (a11, a21, b11, b21) with a squeezed second mode (a22) and a fourth mode (b21) of the four spatial modes (a11, a21, b11, b21) with a squeezed third mode (b12) to produce a new first mode (a13), a new second mode (a23), a new third mode (b13), and a new fourth mode (b23);
interchange the new second mode (a23) with the new third mode (b13) and vice-versa to obtain a four-mode Gaussian entangled states (a14, a24, b14, b24);
a Mach-Zehnder interferometer communicatively coupled to the balanced beam splitter and configured to:
perform a unitary transformation on a new first mode (a14) and a new second mode (a24) of the four-mode Gaussian entangled states (a14, a24, b14, b24) to produce a transformed first mode (a15) and a transformed second mode (a25) and on a new third mode (b14) and a new fourth mode (b24) of the four-mode Gaussian entangled states (a14, a24, b14, b24) to produce a transformed third mode (b15) and a transformed fourth mode (b25);
a plurality of homodyne measurement circuits communicatively coupled to the Mach-Zehnder interferometer and configured to:
perform homodyne measurements on the transformed first mode (a15) and the transformed second mode (a25) of the four-mode Gaussian entangled states (a15, a25, b15, b25) and on the transformed third mode (b15) and the transformed fourth mode (b25) of the four-mode Gaussian entangled states (a15, a25, b15, b25) to obtain a plurality of analog signals (a1ma, a2ma, b1ma, b2ma); and
a plurality of analog to digital converter circuits communicatively coupled to the plurality of homodyne measurement circuits and configured to:
convert the plurality of analog signals (a1ma, a2ma, b1ma, b2ma) into a plurality of digital signals (a1md, a2md, b1md, b2md) representing sequences of random number; and
perform a Bell-CSHS inequality check on the plurality of digital signals (a1md, a2md, b1md, b2md) by setting different unitary transformation.

16. The system as claimed in claim 15, wherein the two-mode squeezing operation is performed by a non-linear medium with a plurality of vacuum input and pumped with a laser light.

17. The system as claimed in claim 15, wherein the homodyne measurements on the four-mode Gaussian entangled states (a15, a25, b15, b25) are performed in a combination of X-quadratures and P-quadratures.

18. The system as claimed in claim 15, wherein a squeezed vacuum state refers to a state of light with a reduced quantum uncertainty in its electric field strength for some phases compared to a vacuum state.
